(19) United States
(12) Patent Application Publication
(10) Pub. No.: US 2006/0210786 A1
(43) Pub. Date: Sep. 21, 2006

(54) Variable density foam

(76) Inventors: James W. Freitag, Kearney, MO (US); Donald W. Taylor, Liberty, MO (US)

Correspondence Address: ORSCHELN MANAGEMENT CO, P O BOX 280, 2000 US HIGHWAY 63 SOUTH, MOBERLY, MO, 65270, US

(21) Appl. No.: 11/368,183

(22) Filed: Mar. 3, 2006

Related U.S. Application Data
(60) Provisional application No. 60/658,918, filed on Mar. 4, 2005.

(51) Int. Cl. B32B 3/26

(52) U.S. Cl. 428/304.4

(57) ABSTRACT

A variable or non-uniform density foam is disclosed. The chemical or physical properties of the foam are non-uniform along at least one dimension, and normally non-uniform along at least two dimensions. Variable density includes areas or regions having the same or substantially the same chemical or physical properties so long as such areas or regions are at least partially in contact with an area or a region with a differing chemical or physical property.

This Application claims the benefit of Provisional Application No. 60/658,918, filed on Mar. 04, 2005. The disclosure of that Provisional Application is hereby incorporated by reference.

### FIELD OF THE INVENTION

The instant invention relates to a heat expandable foam having a variable density.

### BACKGROUND OF THE INVENTION

Heat expandable foams are employed in a wide range of end-uses such as sealants for appliances, commercial and residential buildings, telecommunications, impact absorption, insulation, and automotive applications including sound abatement, among other end-uses. Conventional foams comprise vulcanized elastomeric polymers, e.g., refer to European Patent Application Publication No. 0216990, and U.S. Pat. No. 4,588,752; the disclosure of both of which is hereby incorporated by reference. Examples of foams and sound abatement materials for automotive applications are described in U.S. Pat. Nos. 4,427,481; 4,874,650; 4,923,902; 5,266,133; 5,274,006; 5,373,027; 5,506,025; 5,266,133; 5,373,027; 5,678,826; 6,830,799 and European Patent No. EP 0 730 998B1; the disclosure of each of which is hereby incorporated by reference. One automotive cavity sealing arrangement and method is described in U.S. Pat. No. 5,040,803; the disclosure of which is also hereby incorporated by reference.

While conventional heat expandable foams are useful, conventional foams may not completely fill or seal off a cavity, e.g., an automotive cavity such as an A-pillar. Such incomplete cavity sealing can adversely affect sound propagation and increase sound transmission to an automotive passenger compartment. There is a need in this art for a heat expandable foam that more completely fills or seals a cavity. There is also a need in this art for a preformed sound abatement material wherein one expandable material is capable of sealing a wide range of automotive cavities.

### SUMMARY OF THE INVENTION

The instant invention solves problems associated with conventional foams by providing variable density foam. By “variable density” it is meant that the chemical or physical properties of the foam are non-uniform along at least one dimension, and normally non-uniform along at least two dimensions. Variable density includes areas or regions having the same or substantially the same chemical or physical properties so long as such areas or regions are at least partially in contact with an area or a region with a differing chemical or physical property.

Non-uniformity is achieved by obtaining the foam from at least two foam precursors having different chemical or physical properties, e.g., density, composition, expansion rates, acoustical, compression, strength (e.g., shear, tensile, etc), among other properties. By “precursor or precursors” it is meant to refer to a material, which upon exposure to an amount of heat for a sufficient amount of time, will expand or decrease in density. Precursor(s) include un-reacted viscous compositions (e.g., pumpable compositions), preforms having a defined shaped as well as other self-supporting articles capable of producing a variable density foam.

In one aspect of the invention, the precursor comprises particles, pellets, among other discrete components that are blended together wherein at least two components have different chemical and/or physical properties. The components expand at differing rates, activation temperatures, among other properties thereby forming a variable density foam. The blended components can be stored within a container or other medium that can expand and become a component of the final self-supporting foam. In one particular aspect, precursor pellets are placed within a bag comprising a heat activated adhesive. When exposed to a sufficient amount of heat, the pellets expand within the bag which in turn becomes heated and adheres the expanded foam to a desired surface (e.g., to at least one side of an automotive cavity). In another particular aspect, the precursor is combined or mixed within a medium (e.g., carrier) thereby permitting delivery of the precursor in a fluid system (e.g., the precursor can be applied by dipping, spraying, pumping, among other methods). The medium can be removed after applying the precursor, or become a component of the foamed product.

In another aspect of the invention, the precursor comprises a self-supporting body such as a preform, compact, an extrudant, a package, an assemblage, among a wide range of configurations. One specific aspect of the invention comprises a preform wherein at least two portions or regions of the preform have differing chemical and/or physical properties (e.g., obtained by combining pellets having differing chemical properties and using the combined pellets to produce a perform).

### CROSS REFERENCE TO RELATED PATENTS AND PATENT APPLICATIONS

The subject matter of the instant invention is related to the following U.S. patent application Ser. No. 10/729,339, entitled “Metal-Acrylates as Curing Agents for Polybutadiene, Melamine and Epoxy”, Ser. No. 10/978,081 entitled “Metal-Acrylate Curing Agents, and Ser. No. 11/003,758 entitled “Metallic Acrylate Curing Agents And Usage Thereof In Intermediate Compositions”. The disclosure of these patent applications is hereby incorporated by reference. These Applications disclose a curing agent that can be employed in the instant invention.

### DETAILED DESCRIPTION

The instant invention solves problems associated with conventional foams and foam precursors by providing a non-uniform or variable density foam. The varying density of the foam can provide a foam having improved acoustical energy absorbing properties, among other benefits. The foam can be comprised of Styrene Butadiene rubber, Ethylene propylene rubber, Butyl rubber, Urethane, Ethylene acrylic, Vinyl acetate ethylene, other thermoplastic or thermosetting polymers blended with epoxy, polyester, rubber modifiers or other viscosity modifying materials, at least one expansion agent, and polymer cross-linking compounds.

In the case of an acoustical foam, sound propagation is typically a function of the ability of sound to pass through a given medium. By varying the density of the medium, e.g., variable density foam, through which sound passes, it is possible to reduce sound propagation or transmission. That is, a variable or non-uniform density along at least one dimension of the foam can reduce sound transmission through the foam.

In one aspect of the invention, a foam precursor is prepared which comprises blended or compacted particles or pellets of at least two chemically and/or physically distinct heat expanding materials, e.g., rubber. The components of the pelletized precursor vary in properties such as cell structure (closed v. open celled foam), chemical composition, activation temperature, adhesion to a desired substrate, hardness, expansion rates and ranges, flame and welding resistance, chemical resistance, surface characteristics such as porosity, color, expansion, sag resistance, melting or softening point, density, among other properties. The ratio of the pellets can range in order to obtain an expansion of from about 100% to about 1,000%. Usually it is desirable to employ a relatively high degree of expansion to cost-effectively fill a cavity, while having an amount of solid material sufficient to impart sound dampening characteristics.

The previously described pellets could also be coated to impart adhesive properties among individual pellets, or certain substrates. By coating the pellets, a relatively large amount of adhesive can be incorporated in comparison to surface coating of the precursor. The pellets can also be coated with at least one material for imparting improved corrosion resistance to a metallic surface that houses the expanded foam. Expandable pellets or particles can also be incorporated in a different medium, such as a gel or viscous medium composition which also has expanding characteristics (e.g., a medium that can be dipped, sprayed, pumped or otherwise dispensed). The medium or carrier permits the pellets to be formed into a wide array of configurations. In addition, a sprayable or pumpable medium can be used for delivering the precursor pellets to any suitable location (e.g., into an automotive cavity). The pellets can be tailored to obtain a foam that expands from about 100% to 1,000% (e.g., in order to obtain a desired cost and sound control).

In another aspect of the invention, the precursor pellets can be stored and used by introducing the pellets into a pre-designed container or bag, e.g., a suitable thermoplastic or thermosetting bag. Examples of suitable bag compositions comprise at least one member chosen from the group of ABS polymers, acetals, acrylics, AES polymers, ASA polymers, cellulosic materials, EMAAA terpolymers, ethylene acrylic acids, ethylene butyl acrylates, ethylene methyl acrylates, ethylene vinyl acetates, ethylene vinyl alcohols, fluoropolymers, ionomers, liquid crystal polymers, nylons, phenoxy or phenoxy blends, polyimides, polyimides, polyaryl amides, polyaryl sulfones, polybenzimidazoles, polybutadiene, polybutenes, polycarbonates, polyesters, polybutylene terephthalates, polyethylene terephthalates, poly trimethylene terephthalates, polyetheretherketones, polyetherimides, polyethersulfones, polyethylenes (low to high density), polyketones, polymethyl pentenes, polyphenylene ether/PPO's, polyphenylene sulfides, polyphthalamides, polypropylenes, polystyrenes, polysulfones, polyurethanes, SMA polymers, SAN polymers, styrene-butadienes, TPE elastomers, vinyls, vinyl acetate ethylenes, and blends thereof among others. These may or may not contain functional groups. If desired, the container can comprise at least one suitable adhesive wherein a temperature that is sufficient to activate and expand the pelletized precursor also causes the adhesive of the container to maintain the expanded precursor at a predetermined position (e.g., adhere the expanded precursor or foam within an automotive cavity). Examples of suitable adhesives comprise at least one member chosen from the group of hotmelts, pressure sensitive, or the precursors can be adhered by using a magnetic composition. While any suitable adhesive material can be employed, specific examples comprise the subject matter of U.S. Pat. No. 6,638,590; hereby incorporated by reference, ORB™ series of pumpable products supplied by HenkelOrbseal LLC, among others. If desired, the container or bag can possess a configuration that channels or directs the expanding precursor into a predetermined direction, e.g., along the length of an elongated cavity. The contained pellets, when exposed to heat, such as a typical automotive paint bake oven, would foam to expand and fill the desired cavity.

In another aspect of the invention, at least one of the foam precursors comprises an epoxy functional compound that is cured with at least one metal acrylate (e.g., zinc diacrylate) such as described in the aforementioned Cross Reference To Related Patents and Patent Applications. If the foam precursor is delivered in a medium, the medium can also comprise an epoxy functional compound that is cured with a metal acrylate (and is substantially free of conventional curing agents).

Depending upon the function of the foam and/or volume of cavity being filled by the foam, more than one precursor can be employed. The precursors can be arranged in any suitable manner including linear, circular, curvilinear, among other configurations that orient the precursors for expanding and filling a cavity. The foam precursor can also comprise multiple layers of extruded material, and be fabricated by injection molding, co-extrusion, or by pumping at least two materials.

The resultant foam can comprise open and/or closed cells. If desired, the foam precursor can incorporate at least one filler or reinforcing member chosen from the group of powders, fibers, chopped fibers, plates, particles, rods, bubbles, spheres and liquids such as antioxidants, brighteners-colorants-dyes, calcium carbonate, cellulose complexes (e.g. methyl), ceramic, clays, corrosion inhibitors, flame retardants (e.g. aluminum trihydrate, zinc borate, among others), Gilsonite, glass, glass mesh, light absorbers incl WV, magnetics, metal (ferrous and non-ferrous), oxide complexes (e.g. calcium, zinc, among others), phosphate complexes (e.g. zinc), polyvinyl alcohol, reactive fillers (e.g. epoxy functional, phenoxy, among others), silica and silicates, stearate complexes (e.g. lithium, zinc, among others), talcs, thermal stabilizers, whitening agents, among other filler materials effective at forming a composite. The filler will normally comprise less than about 40 wt %, but can be varied with the expansion desired. If desired, the foam precursor can be laminated or otherwise in contact with a film, sheet or surface of a relatively thick self-supporting article, among other conventional laminated surfaces.

The precursors can be self-retaining within a cavity or location, e.g., a precursor shaped as a clip such as described in U.S. Pat. No. 6,830,799; hereby incorporated by reference. The precursors can also be maintained in a predetermined location by employing at least one fastening device. Examples of suitable fastening devices comprise pins, clips, supports, among other conventional fastening devices.

The following Examples are provided to illustrate certain aspects of the invention and not to limit the scope of the invention as defined by appended claims. Unless indicated otherwise, percent refers to weight percent. EXAMPLE 1

Formulas A-D were fabricated by mixing in a double arm Baker Perkins mixer. The formulated materials were then pelletized by extruding through screen and chopping knife. Pellets from each of the formulations were combined by dry blending in a Hobart mixer. Pellet size was 0.125″ diameter and were mixed in a ratio of 1:1:1(A:B:C) and 120 grams of the blend was placed into a 9 ounce size thermoplastic polyethylene bag. (Bag size and pellet size may be altered for specific applications). The pellets were then placed into an oven and heated to a temperature of 350° F. for 30 minutes. The pellets within the bag expanded to produce a variable density foam.

Formulation A

| Tradename | Composition | Supplier | Wt. % |
|---|---|---|---|
| Nordel ® 4725 | Ethylene Propylene | DuPont | 34% |
| Flexon ® 580 | Hydrocarbon oil | Exxon | 32% |
| Industrene R | Stearic acid | Crompton | 1.7% |
| Regal 300 | Carbon black | Cabot | 1.7% |
| Celogen Az | Blowing agent | Crompton | 8.6% |
| Sulfur | Sulfur | Akrochem | 0.5% |
| AZO 77 | Zinc Oxide | USARCO | 3.5% |
| Magsil 399 | Magnesium silicate | Whittaker | 18% |

Formulation B

| Tradename | Composition | Supplier | Wt. % |
|---|---|---|---|
| 8107 rubber | StyreneButadiene Rubber | Synpol | 43% |
| 1205 rubber | Styrene Butadiene Rubber | Synpol | 7.5% |
| Sylvatac ® 5N | Hydrocarbon resin | Sylvachem | 6.4% |
| Tuex | TMTD | Crompton | 1.3% |
| Regal 300 | Carbon black | Cabot | 0.5% |
| TBP | (Peroxide) | Lucidol | 1.3% |
| Elvax 205W | EVA resin | DuPont | 23% |
| FP 800 | Polypropylene powder | Equistar | 7.5% |
| Celogen ® OT | Blowing agent | Crompton | 5.2% |
| AZO 77 | Zinc oxide | USARCO | 3.8% |
| Industrene R | stearic acid | Crompton | 0.5% |

Formulation C

| Tradename | Composition | Supplier | Wt. % |
|---|---|---|---|
| Vamac DP | Ethylene Acrylic Rubber | Dupont | 43% |
| Epon 828 | Epoxy resin | Resolution | 11% |
| SR 9016 | ZDA | Sartomer | 1% |
| Regal 300 | Carbon black | Cabot | 0.5% |
| Vulcup 40 KE | (Peroxide) | Lucidol | 1% |
| Optema TC 140 | EMA resin | Exxon/Mobil | 33% |
| FP 800 | Polypropylene powder | Equistar | 6.5% |
| Celogen ® OT | Blowing agent | Crompton | 4% |

Formulation D

| Tradename | Composition | Supplier | Wt. % |
|---|---|---|---|
| Vamac DP | Ethylene Acrylic Rubber | Dupont | 35% |
| Epon 828 | Epoxy resin | Resolution | 35% |
| SR 9016 | ZDA | Sartomer | 3.5% |
| Regal 300 | Carbon black | Cabot | 0.3% |
| Vulcup 40 KE | (Peroxide) | Lucidol | 0.8% |
| Optema TC 140 | EMA resin | Exxon/Mobil | 17% |
| FP 800 | Polypropylene powder | Equistar | 5% |
| Celogen ® OT | Blowing agent | Crompton | 3.4% |

Pellets of Formulation D were formed in the manner described above and into a cylindrical shape by hand rolling on a release sheet. The shaped formulation was then placed in a mechanical convection oven and heated to a temperature of 350° F. for 30 minutes to produce a variable density foam article.
Formulations C and D also demonstrate using a metal monomer (i.e., zinc diacrylate) to cure an epoxy functional compound within the variable density foam.

### EXAMPLE 2

Pelletized expandable material A was blended with E-2400 (available from Denovus LLC, Excelsior Springs, Mo.) by blending in a Hobart type mixer. E-2400 comprises polybutene, epoxy and at least one silicate and is described in greater detail in U.S. Pat. No. 6,331,509 entitled “Corrosion Resistant Lubricants, Greases and Gels”; the disclosure of which is hereby incorporated by reference. The blended material was introduced into an oven at 350° F. for about 30 minutes at which time the material expanded to produce a foam. The resulting foam expanded normally, and was coated with the E-2400 material

### EXAMPLE 3

Example 2 was repeated, except that 0.125 inch diameter pellets of A & B of Example 1 were combined with EDC® 2400. The ratio used in the test sample was 2:1 pellets to EDC® 2400. Mixture was baked at temperature of 340° F. for 25 minutes. Pellets expanded and remained coated with the EDC 2400.

### EXAMPLE 4

Pellets of Formulations A, B and C from Example 1 were blended in Formulation D and formed by rolling into cylindrical shape of 3″ length and ½″ diameter. (Ratio of 1:1:1(A:B:C) 25 grams of each in 200 grams of sample of formulation D). The cylindrical shaped part was placed on a 4″×6″ metal panel and placed in a mechanical convection oven at 340° F. for 30 minutes. The part expanded to form a variable density foam article.

The following is claimed:

1) A heat expanded foam comprising at least two regions wherein the two regions have different chemical composition.

2) An automotive sound abatement foam comprising a heat expanded foam comprising at least two regions wherein the two regions have different chemical composition.

3) The foam of claim 1 wherein the two regions are obtained from precursor pellets that are placed within a bag comprising a heat activated adhesive.

4) The foam of claim 1 wherein the foam is obtained from a precursor comprising pellets having different chemical composition and the pellets are combined with a carrier medium.

5) The foam of claim 1 wherein the foam is obtained from a precursor having at least two different chemical compositions and comprises a self-supporting body.

6) A heat expandable foam precursor composition comprising pellets having at least two different compositions.

7) The precursor of claim 6 wherein the composition is pumpable.

8) The precursor of claim 6 wherein the composition has a predetermined configuration.

9) The precursor of claim 6 wherein the pellets are coated.

10) The precursor of claim 6 wherein the pellets are contained within a thermoplastic container.

11) The precursor of claim 6 wherein the pellets comprise at least one expansion agent and at least one member selected from the group consisting of ethylene propylene, styrene butadiene rubber, ethyl vinyl acetate resin, ethylene acrylic rubber, and epoxy resin.
